(19) United States
(12) Patent Application Publication
(10) Pub. No.: US 2007/0034441 A1
(43) Pub. Date: Feb. 15, 2007

(54) Drive train and method for controlling and regulating a drive train

(76) Inventors: Christoph Pelchen, Tettnang (DE); Barbara Schmohl, Friedrichshafen (DE); Ulrich Mair, Friedrichshafen (DE)

Correspondence Address: DAVIS & BUJOLD, P.L.L.C., 112 PLEASANT STREET, CONCORD, NH, 03301, US

(21) Appl. No.: 10/573,511

(22) PCT Filed: Sep. 21, 2004
(86) PCT No.: PCT/EP04/10551

§ 371 Date: Mar. 27, 2006

(30) Foreign Application Priority Data
Sep. 27, 2003 (DE) 10344969.8

(51) Int. Cl. B60K 17/00

(52) U.S. Cl. 180/337

(57) ABSTRACT

A power train and a method for controlling and regulating a power train of a motor vehicle with at least two drivable motor vehicle axles. A main transmission is arranged between a motor and the motor vehicle axles for representing various gear ratios. Furthermore, a controllable and regulatable clutch is provided between the main transmission and each of the motor vehicle axles, respectively, whose transmission capacity is respectively adjustable by means of an actuator system. A drive torque can be distributed between the motor vehicle axles as a function of the set transmission capacities of the clutches. The transmission capacities of the clutches can be adjusted to the distribution of the drive torque as needed and optimized as to efficiency by the actuator system such that one clutch can be operated in a slip operation, while the other clutch can be held at least nearly in a synchronous state.

This application is a national stage completion of PCT/EP2004/010551 filed Sept. 21, 2004 which claims priority from German Application Serial No. 103 44 969.8 filed Sept. 27, 2003.

### FIELD OF THE INVENTION

The invention concerns a power train of a motor vehicle with at least two drivable motor vehicle axles and with a main transmission arranged between a motor and the vehicle axles and a method for controlling and regulating a power train of this type in accordance with the features of the preamble of patent claim 10.

### BACKGROUND OF THE INVENTION

In power trains of motor vehicles known from practice, drive torque generated by a motor is led as needed through a transmission to the drive gears. If motor vehicles, such as four-wheel drive automobiles or four-wheel drive trucks, are constructed with multiple driven axles. The output of the motor is distributed in the power train of a motor vehicle of this type to the individual drive axles and the various drive gears.

The above-described output distribution occurs, in general, in connection with so-called differential transmissions, wherein center differential transmissions, viewed in the direction of travel, are used for the longitudinal distribution of driving power from the motor to several driven motor vehicle axles. So-called cross differentials or differential gearings are provided to allow a cross distribution of the driving power to drive gears of a motor vehicle, relative to the direction of travel of a motor vehicle.

The types of differential gearings usually used in practice are so-called bevel differentials, spur differentials in planetary construction or also worm drives. In particular, spur differentials are usually used as center differentials owing to the possibility of asymmetrical torque distribution. In the meantime, bevel differentials are the standard for cross compensation in motor vehicles. Worm gear differentials are used for longitudinal distribution as well as for a cross distribution.

With known differential-controlled four-wheel drives or four-wheel systems of this type, the torque distribution to the front and the rear axle takes place through a planetary gear or a bevel differential. With planetary gear differentials, the drive torque can be distributed to the two drive axles or vehicle axles at will by selecting the gear ratio. Common torque distributions between the front and rear axle lie at 50%:50% up to 33%:66%. With bevel differentials, the torque distribution is fixed at 50%:50%. By selecting a fixed torque ratio between the front and rear axles. The tractive force distribution is ideal only for one point, the design point.

The drive torque thus is not distributed proportionally to the axle load that corresponds to the momentary driving state. In the event of severe slippage, if the traction reserves are completely used up, which theoretically is possible only in the case of variable torque distribution between the front and rear axles, the center differential can be braked or blocked. Through a blocking action continuously occurring with increasing speed difference as, for example using a viscous blockage, driving behavior is not negatively affected and continuous strains in the power train, such as occur with positive differential locks, are avoided.

Beyond this, so-called clutch-controlled four-wheel drives are known in which clutches, for example disk clutches with a clutch torque adjustable from the outside, are used. With these, the clutch torque can be selected to correspond to the momentary drive status of the vehicle. In this way, it is possible to adapt the distribution of torque between the front and rear axles to dynamic axle load changes, in other words, dependent upon acceleration, inclination, load, etc.

Furthermore, mixed forms, i.e., so-called differential and clutch-controlled systems, are known in which the four-wheel drive is realized through an electronically switchable, multi-plate clutch and/or a locking differential.

However, one disadvantage of such systems is that a variable torque distribution in the power train is achieved by a slip operation of the clutches, which results in a decrease in the efficiency of such a power train.

The present invention is, therefore, based upon the objective of furnishing a power train and a method for controlling and regulating a power train, where a simple distribution of drive torque to multiple drive axles can be implemented as required and optimized as to efficiency.

### SUMMARY OF THE INVENTION

With the power train of a motor vehicle as specified in the invention, which is constructed with at least two drivable motor vehicle axles and with a main transmission between a motor and the vehicle axles for presenting various gear ratios and which, in each case, has a controllable and regulatable friction-locking clutch in the longitudinal power trains between the main transmission and the vehicle axles. The transmission capacity is respectively adjustable through an actuator system. A drive torque of the motor can be distributed between the drivable motor vehicle axles as a function of the variable transmission capacities of the clutches wherein, at all times, one of the clutches is operable with slipping for variable distribution of the drive torque between the drivable axles, while an additional clutch can be maintained in a synchronous state.

In this way, it is assured that the power loss of the clutch-controlled four-wheel drive of a motor vehicle always occurs in only one of the clutches of the longitudinal power trains while the other clutch is operated loss-free in a synchronous state.

With the method of the invention for controlling and regulating a power train in which, to distribute drive torque between the drivable motor vehicle axles, the transmission capacities of the two clutches are adjusted such that one of the clutches of the longitudinal power train is operated in a synchronous state while the other clutch is operated with slipping, the efficiency of the power train can be improved in a simple manner. For this, the transmission capacity of the clutch that is slip operated is varied between a lower threshold and an upper threshold, which corresponds to a synchronous state of the second clutch. Here the drive torque can be distributed in any desired ratios, i.e., with degrees of distribution of the drive torque of between 0% and 100%, between the drivable motor vehicle axles as needed and optimized in terms of efficiency.

### BRIEF DESCRIPTION OF THE DRAWINGS

The invention will now be described, by way of example, with reference to the accompanying drawings in which:

FIG. 1 is a highly schematic representation of a power train of a motor vehicle in accordance with the invention;

FIG. 2 is a graphic representation of a connection between the transmission capacities of the clutches of the power train in accordance with FIG. 1 and a degree of distribution of the drive torque between two drivable axles of the power train;

FIG. 3 is a basic diagram of a first embodiment of an actuator system for adjusting the transmission capacities of the two clutches from FIG. 1;

FIG. 4 is a second embodiment of the actuator system for adjusting the transmission capacities of the clutches from FIG. 1;

FIG. 5 is a third embodiment of the actuator system of the power train of the invention;

FIG. 6 is a fourth embodiment of the actuator system wherein, in each case, a clutch is drivable by a drive unit, and

FIG. 7 is a fifth embodiment of the actuator system of a power train of the invention.

### DETAILED DESCRIPTION OF THE INVENTION

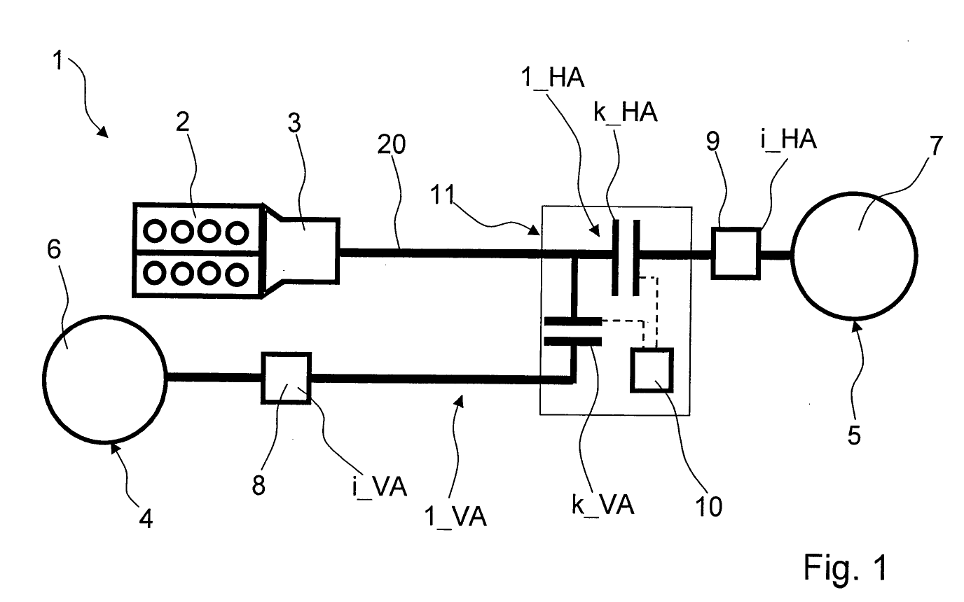

FIG. 1 illustrates a power train 1 of a four-wheel drive motor vehicle in a highly schematic representation. The power train 1 comprises a drive unit or an internal combustion engine 2 and a main transmission 3, which can be any transmission inherently known in the art.

Between the main transmission 3, which is provided for presenting different gear ratios, and two drivable motor vehicle axles 4, 5 of the motor vehicle, which are connected to at least one drive gear 6, 7 in a known manner on each side of the motor vehicle, two clutches k_HA and k_VA are arranged in longitudinal power trains I_HA and I_VA, in other words, between the main transmission 3 and apparatuses 8, 9 for compensating for differential rotational speeds between the drive gears 6 of the motor vehicle axle 4 and the drive gears 7 of motor vehicle axle 5, which apparatuses 8, 9 are constructed in the present case as inherently known cross distributor gears. Furthermore, the portion of the drive torque that is fed respectively to drive axles 4 and 5 is forwarded via the apparatuses 8, 9 to the drive gears 6 and 7 and is distributed between the drive gears 6 or 7 of the relevant drive axle 4 or 5 as needed.

The two cross distributor gears 8 and 9 offer the possibility of driving the drive gears 6 and 7 of the drive axles 4 and 5 independently of one another, corresponding to the different path lengths of the left or right travel lane at different speeds, whereby the drive torque is distributed symmetrically and consequently free of yawing torque between drive gears 6 or 7 of a drive axle 4 or 5.

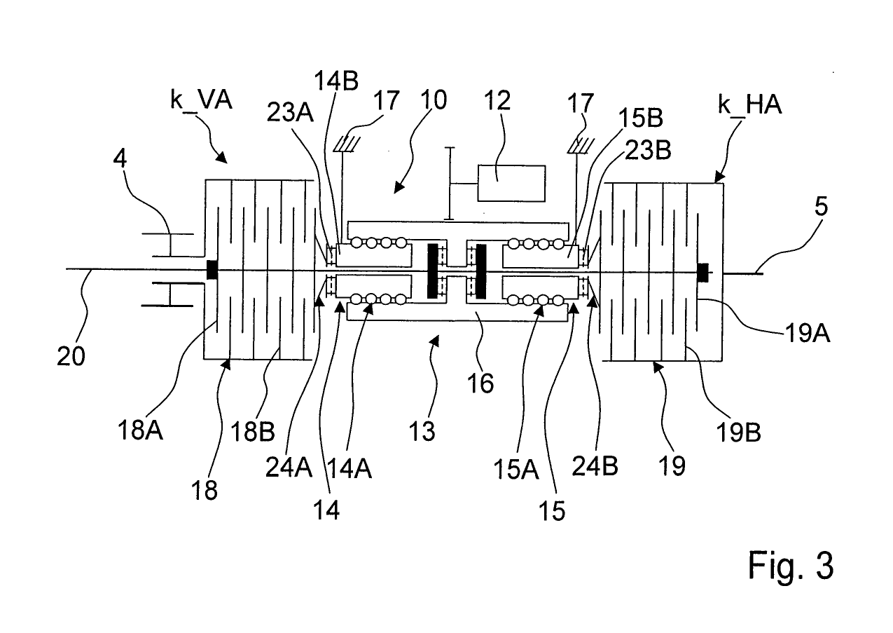

The two clutches k_HA and k_VA are constructed in the present case as controllable and regulatable friction-locking, multi-plate clutches whose transmission capacity in each case is adjustable via an actuator system 10 represented in FIG. 3 to FIG. 7 in various constructions, and which are arranged in the region of a transmission output of a transfer case 11 represented only schematically in FIG. 1. With clutches k_HA and k_VA, it is possible to distribute drive torque from the motor 2 or transmission output torque from the main transmission 3, variably and as needed, between the two drivable motor vehicle axles 4, 5.

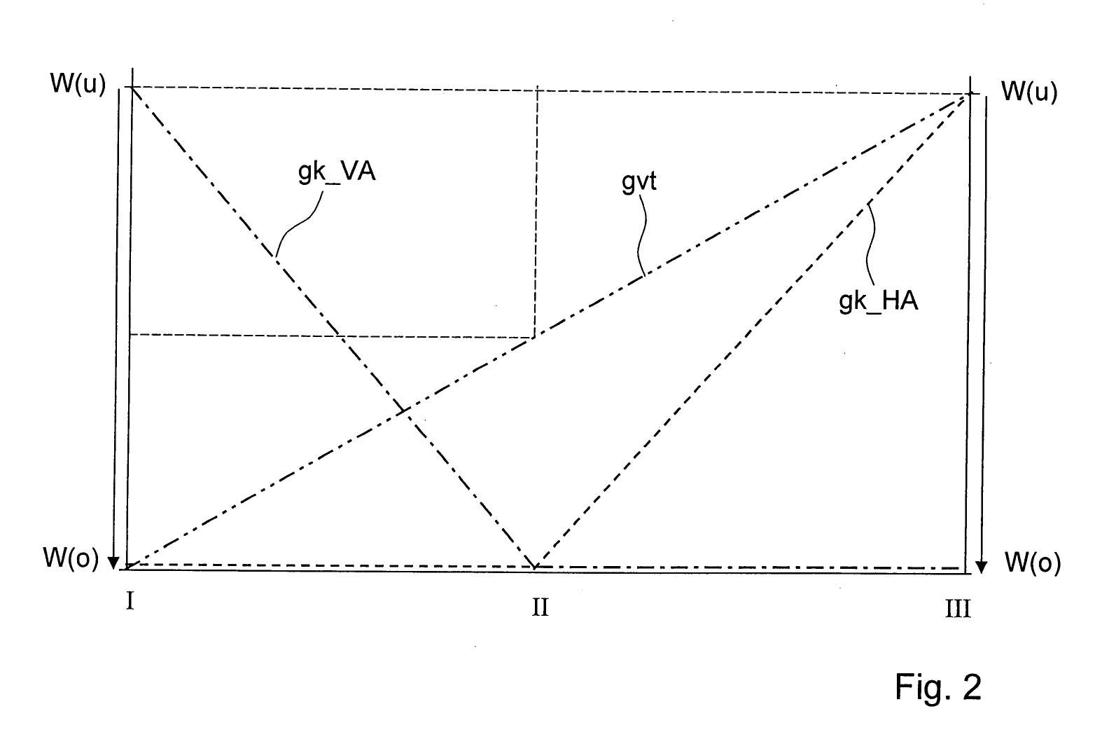

The actuation of the two clutches k_HA and k_VA and the resulting distribution of the incident drive torque to the two motor vehicle axles 4 and 5 is explained in greater detail on the basis of the representation in FIG. 2.

FIG. 2 shows three highly schematic curves, wherein a first curve gk_VA represents a course of a transmission capacity of the first clutch k_VA between a lower threshold W(u) and an upper threshold W(o). An additional curve gk_HA represents the course of the transmission capacity of the second clutch k_HA, which corresponds to the curve gk_VA of the first clutch k_VA. A third curve gvt graphically represents the course of a degree of distribution of the drive torque between the two motor vehicle axles 4 and 5, wherein in the present case the motor vehicle axle 4 represents a front axle VA and the motor vehicle axle 5 represents a rear axle HA of a four-wheel drive motor vehicle.

At Point I, where the transmission capacity of the first clutch k_VA corresponds to the lower threshold W(u), basically no torque is transmitted via the first clutch k_VA. At the same time, the transmission capacity of the second clutch k_HA is set to the upper threshold W(o), at which the second clutch k_HA is in a synchronous state and no slipping occurs between the two clutch halves of the second clutch k_HA. In this operating state of the two clutches k_VA and k_HA, the overall drive torque of the motor is fed to the rear axle 5.

In the region between Point I and a second Point II of the diagram of FIG. 2, the transmission capacity of the second clutch k_HA is adjusted in a controlled and regulated manner such that the clutch k_HA remains in its synchronous state. At the same time, the transmission capacity of the first clutch k_VA is changed from its lower threshold W(u), where it transmits no torque in the direction of the upper threshold W(o) of transmission capacity, at which the first clutch k_VA is likewise situated in its synchronous state. This means that the transmission capacity of the first clutch k_VA is constantly raised in the area between Point I and Point II. The result of this is that the degree of distribution of drive torque between the two motor vehicle axles 4 and 5 changes since, with rising transmission capacity of the first clutch k_VA, an increasing portion of the drive torque is directed to the front motor vehicle axle 4.

When the power train 1 is in the operating state that corresponds to Point II of the diagram of FIG. 2, in which the two clutches k_VA and k_HA are in a synchronous state, there exists a defined degree of distribution of the drive torque between the two motor vehicle axles 4 and 5.

In a region between the Point II and a Point III of the diagram of FIG. 2, the transmission capacity of the first clutch k_VA is set in a regulated and controlled manner such that the first clutch k_VA is maintained in its synchronous state. At the same time, the transmission capacity of the second clutch k_HA is constantly reduced, proceeding from the upper threshold W(o) of transmission capacity, at which the second clutch k_HA is synchronous, in the direction of the lower threshold W(u) of transmission capacity. The second clutch k_HA basically no longer transmits any torque in the direction of the rear motor vehicle axle 5.

As can be seen in FIG. 2, the curve gvt of the degree of distribution of drive torque between the motor vehicle axles 4 and 5 rises with an increasing reduction of the transmission capacity of the second clutch k_HA up to its maximal value at Point III, in which the drive torque is completely transmitted to the front axle 4.

Using the two controllable and regulatable clutches k_HA and k_VA, it is possible to distribute the drive torque of the internal combustion engine 2 or the transmission output torque of the main transmission 3 as needed, continuously and optimized in terms of efficiency, between the motor vehicle axles 4 and 5. An improvement of the efficiency is attained by the previously described method of the invention in connection with the control and regulation of the two clutches since one of the two clutches k_VA or k_HA is constantly operated free of slipping, while the other clutch k_HA or k_VA is operated at a differential rotational speed that corresponds to the distribution of drive power in the power train that is a function of the operating situation. By means of this operating strategy, friction losses can be minimized with all the advantages of a clutch-controlled, four-wheel drive.

Furthermore, by using the two controllable and regulatable clutches k_VA and k_HA in the transfer case 11, it is advantageously possible to construct the main transmission 3 without a separate starting element such as, for example, a hydrodynamic torque converter or a friction-locking starting clutch or without having to incorporate a starting element as an additional component in the power train, since either one of the two clutches k_VA or k_HA, or both clutches k_VA and k_HA, can assume the function of a starting element.

If the main transmission 3 is, for example, constructed as a continuously variable transmission with a chain variator, it is advantageously possible to shift the variator into its starting gear ratio while the motor vehicle is standing, since the standing output of the motor vehicle is separated from the main transmission 3 when clutches k_VA and k_HA are open.

Furthermore, based upon the construction of the power train 1 with the two clutches k_VA and k_HA, an optimal influence upon the driving dynamics, traction and stability of a motor vehicle constructed with the power train of the invention is guaranteed and the power train can, moreover, be executed with a lesser weight in comparison with solutions known in the art.

Five exemplary embodiments of the actuator system 10 for controlling and regulating the two clutches k_VA and k_HA, merely represented schematically in FIG. 1, are represented in FIG. 3 to FIG. 7, wherein for purposes of clarity, the same reference numbers are used for components having the same structure and function in the description for FIG. 3 to FIG. 7.

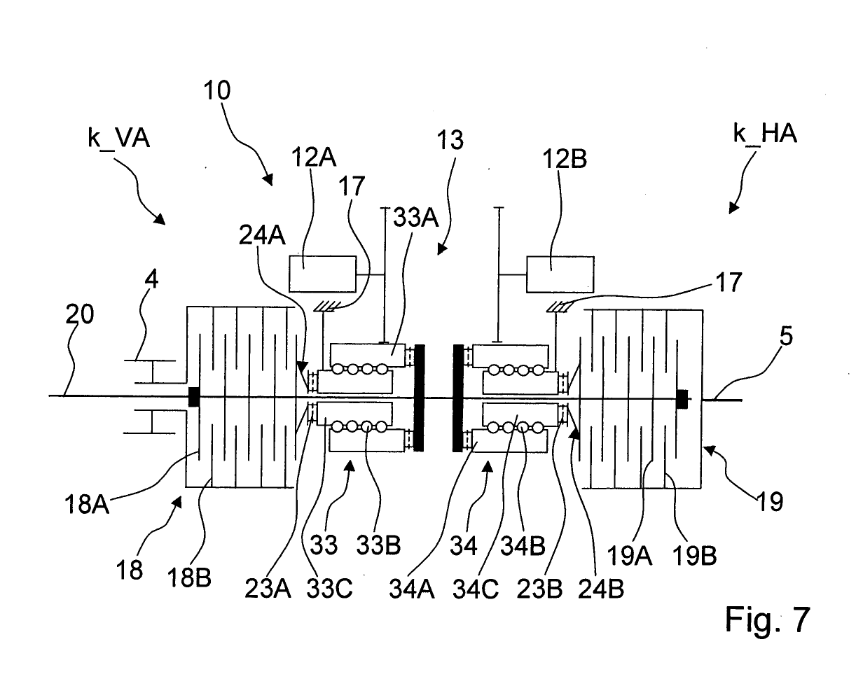

With the exemplary embodiments of the actuator system 10 represented in FIG. 3 to FIG. 6, the two clutches k_HA and k_VA are each simultaneously actuated by a single actuator 12, whereas in the embodiment of the actuator system represented in FIG. 7, the clutches k_VA and k_HA are actuated by separate actuators 12A and 12B, respectively.

In reference to FIG. 3, the actuator system 10 is constructed with an electric motor as the actuator 12 whose rotary drive motion can be converted into a linear activation motion for clutches k_VA and k_HA by way of a converter apparatus 13. The converter apparatus 13 has two ball-type linear drives 14 and 15 operatively connected to one another, wherein the operative connection of the two ball-type linear drives 14 and 15 is formed in that the ball-type linear drives 14 and 15 have a common nut 16 that is fixed into place axially and rotationally drivable by the electric motor 12, and is in operative connection with spindles 14B and 15B via ball screws 14A and 15A. Spindles 14B and 15B of the ball-type linear drives 14,15 are non-rotatably connected to housing-fast components 17 and are designed to move in the axial direction of the nut 16 such that a rotation of a nut 16 causes translational movement of the spindles 14B and 15B in the axial direction of a drive shaft 20.

The clutches k_VA and k_HA, constructed in the present case as multi-plate clutches, or their disk stacks 18 and 19 are opened or are in friction engagement as a function of an axial position of the spindles 14B and 15B of the ball-type linear drives 14 and 15. In this, internal disks 18A and 19A of the clutches k_VA and k_HA are non-rotatably connected to the drive shaft 20, via which the transmission output torque from the main transmission 2 occurs. External disks 18B or 19B of the clutches k_VA or k_HA are, in turn, connected to the front axle 4 or the rear axle 5.

Taking into account the control and regulation of the clutches k_VA and k_HA described in reference to FIG. 2, the axial adjustment of the spindles 14B and 15B of the ball-type linear drives 14 and 15 is opposed to one another, as a function of the direction of rotation of the nuts 16 proceeding from the electric motor 12.

This means that with an initial rotational direction of the electric motor 12—for example toward the right, in which the spindle 14B is shifted in the direction of the disk stack 18 of the first clutch k_VA, and proceeding from an operating state of the clutches k_VA and k_HA that corresponds to the state at Point I of the diagram of FIG. 2, the transmission capacity of the clutch k_VA is increased.

At the same time, the spindle 15B is shifted in the same direction as spindle 14B, away from the disk stack 19 of the second clutch k_HA, which is synchronous. In this, at first nothing changes in the synchronous state of the second clutch k_HA. If the electric motor 12 continues to actuate the nut 16 in the aforementioned direction of rotation, the transmission capacity of the first clutch k_VA is increased until the first clutch k_VA likewise reaches its synchronous state. At the same time, the surface pressure that is applied by the spindle 15B to the disk stack 19 of the second clutch k_HA is continuously reduced, wherein the second clutch k_HA remains at the Point II of the diagram of FIG. 2 in its synchronous state, since the surface pressure of the spindle 15B on the disk stack 19 of the second clutch k_HA continues to suffice to prevent slipping or a differential rotational speed between the internal disks 19A and the external disks 19B of the disk stack 19 of the second clutch k_HA.

If the nut 16 is further actuated in the previously described manner in the same direction of rotation by the electric motor 12, and if the spindles 14B and 15B are increasingly shifted linearly in the direction of the disk stack 18 of the first clutch k_VA, the second clutch k_HA will transition into a slipping operation while the first clutch k_VA is in a synchronous state. The transmission capacities of the two clutches present here are graphically represented by the curves gk_VA and gk_HA in FIG. 2 between Point II and Point III.

This means that the transmission capacity of the clutch k_HA with an increasing shifting path of spindle 15B that is allocated to the second clutch k_HA is reduced such that the latter passes over into slip operation. At the same time, the surface pressure and the transmission capacity of the clutch k_VA is increased by the progressing translational movement of the spindle 14B that is allocated to the first clutch k_VA in the direction of the disk stack 18. The amount of drive torque that is directed to the front axle 4 increases as a function of the reduction of transmission capacity of the second clutch k_HA, until the drive torque is completely directed to the front axle. The latter case corresponds to the operating states of clutches k_VA and k_HA at Point III of the diagram of FIG. 2.

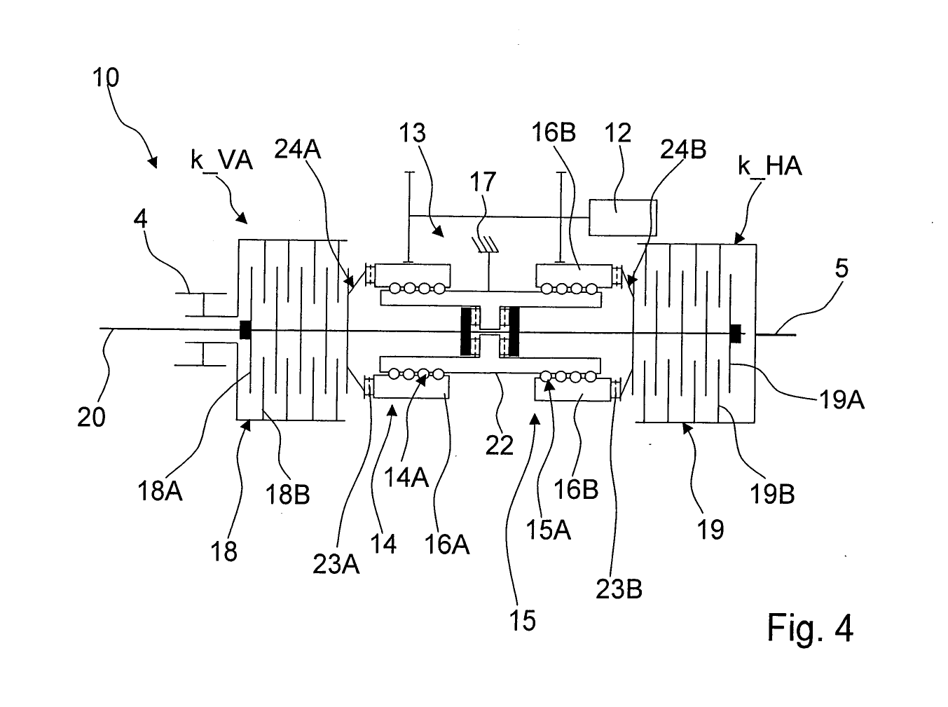

FIG. 4 illustrates a further exemplary embodiment of the actuator system 10, wherein the converter apparatus 13 in accordance with FIG. 4 is constructed with a single spindle 22 and two separate nuts 16A and 16B, in contrast to the converter apparatus 13 of FIG. 3. The spindle 22, which is designed as a single piece, is rotationally and translationally fixed to the housing-fast component 17, and the nuts 16A and 16B are actively connected to the spindle 22 such that they can be shifted via the ball screws 14A and 15B rotationally and in the axial direction of the drive shaft 20.

The nuts 16A and 16B are moved in the same manner as the spindles 14B and 15B shown in FIG. 3 via the rotational drive power of the electric motor 12 on the disk stacks 18 and 19 toward or away from them, wherein between the disk stacks 18 and 19 of the clutches k_VA and k_HA and the nuts 16A and 16B, in the same manner as between the spindles 14B and 15B of the ball-type linear drives 14 and 15 of FIG. 3 and the disk stacks 18 and 19. In each case axial needle bearings 23A and 23B and spring devices 24A and 24B are provided.

The axial needle bearings 23A and 23B are provided for lower loss compensation for differential rotational speeds between the spindles 14B and 15B or the nuts 16A and 16B and the disk stacks 18 and 19, as well as for transmitting surface pressures from the converter apparatus 13 to the disk stacks 18 and 19. The spring devices 24A and 24B in the present case each represent a suitable means for applying the surface pressures from the converter apparatus 19 in a suitable manner to the disk stacks 18 and 19.

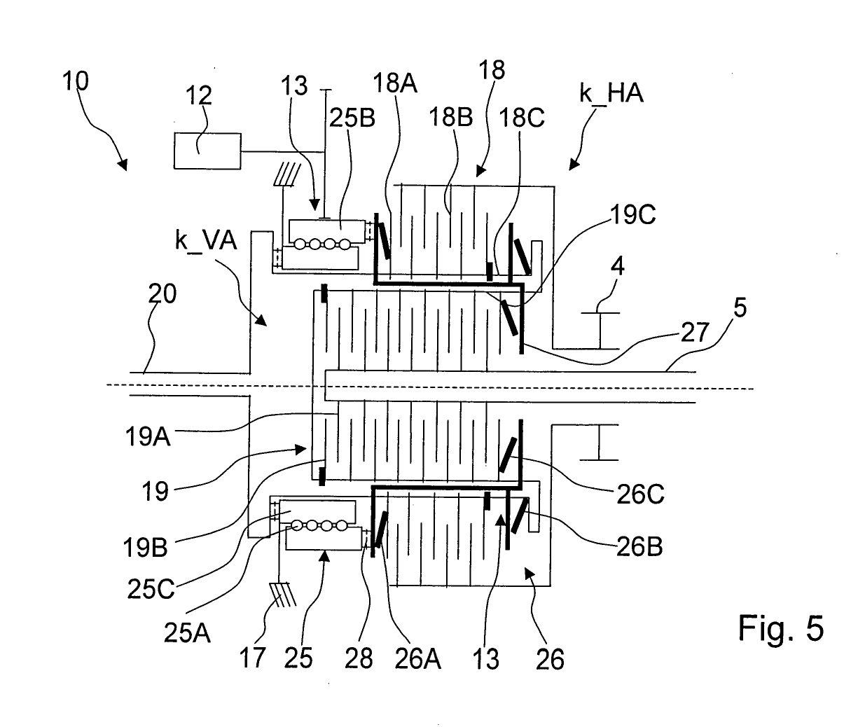

With the embodiment of the actuator system 10 represented in FIG. 5, the clutches k_VA and k_HA are arranged co-axially relative to one another, and the clutch k_HA is integrated into the clutch k_VA. This arrangement of the clutches k_VA and k_HA results in a smaller axial construction length of the transfer case 11 of the power train 1 in the region of the two clutches k_VA and k_HA than the arrangement of the clutches k_VA and k_HA shown in FIG. 3 and FIG. 4.

The converter apparatus 13 of the actuator system 10 in accordance with FIG. 5 is executed with only one ball-type linear drive 25 which includes a spindle 25C fixed in place on the housing side and a nut 25B, which can be rotationally driven by the electric motor 12 and translationally moved in the direction of the drive axle 20, wherein the spindle 25C and the nut 25B are operatively connected to one another by a ball screw 25A. The drive shaft 20 in the present case is connected to an internal disk carrier 18C of the disk stack 18 of the clutch k_VA and to an external disk carrier 19C of the disk stack 19 of the clutch k_HA.

Furthermore, the actuator system 10 is constructed with a spring system 26, by way of which the control and regulation of the clutches k_VA and k_HA described in FIG. 2 can be implemented with only one translationally movable component 27, as a function of a translational movement of the nut 25B of the ball-type linear drive 25.

The spring system 26 comprises springs 26A, 26B, 26C constructed as cup springs and situated between the component 27 (which lies on the nut 25B or on an additional axial needle bearing 28) and the internal disks 18A or the external disks 18B of the disk stack 18 of the first clutch k_VA, between the component 27 and the internal disk carrier 18C of the disk stack 18 of the first clutch k_VA, and between the component 27 and the internal disks 19A or the external disks 19B of the disk stack 19 of the second clutch k_HA, respectively. The cup springs 26A, 26B and 26C are moreover arranged such that a translational movement of the nut 25B in the direction of the disk stacks 18 and 19 of the clutches k_VA and k_HA results in an elevation of the surface pressure of the disk stack 18 of the clutch k_VA and a simultaneous reduction in the surface pressure of the disk stack 19 of the clutch k_HA. If the nut 25B of the ball-type linear drive 25 is moved away from the disk stacks 18 and 19 of the clutches k_VA and k_HA, the surface pressure on the disk stack 18 of the first clutch k_VA is reduced and the surface pressure on the disk stack 19 of the second clutch k_HA is increased.

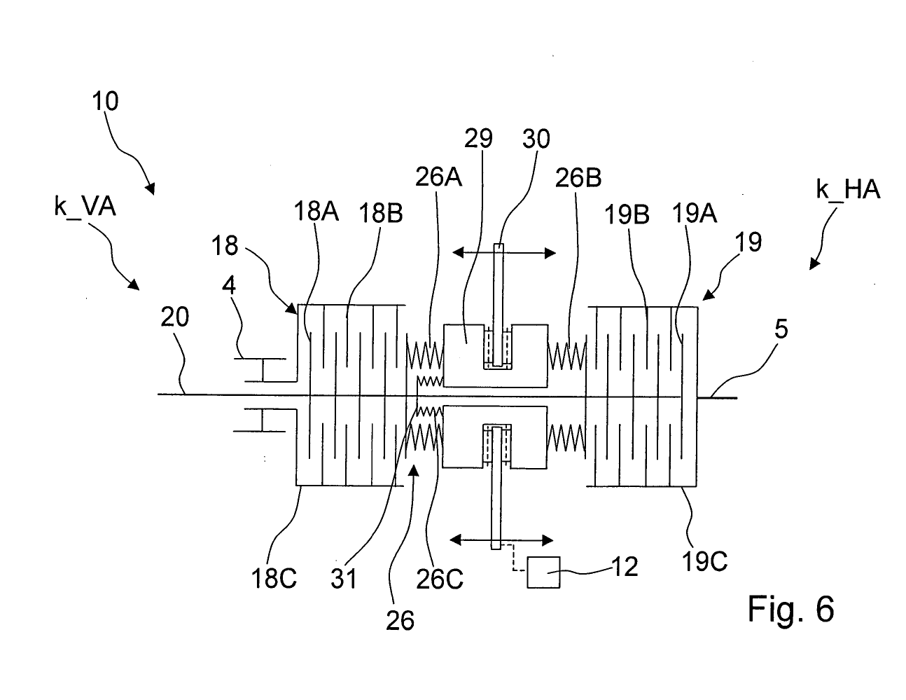

A further exemplary embodiment of the actuator system 10 is represented in FIG. 6, in which the transmission capacities of the clutches k_VA and k_HA can be controlled and regulated by way of a sliding sleeve 29 that is arranged movably on the drive shaft 20. A spring system 26 with springs 26A, 26B and 26C is, in turn, arranged between the sliding sleeve 29 and each of the disk stacks 18 and 19 of the clutches k_VA and k_HA. The surface pressure, which is applied as a function of the axial position of the sliding sleeve 29 by the spring system 26 respectively to the disk stacks 18 and 19 of the clutches k_VA and k_HA, is transmitted by the springs 26A to 26C in a suitable manner.

An adjustment lever element 30 engages into the sliding sleeve 29, which can be activated translationally by the actuator 12 in the directions represented by the double arrow in FIG. 6. The actuator 12, which in FIG. 6 is represented highly schematically, is constructed in this case as an electric motor. The rotational drive of the electric motor 12 is transmitted for activation of clutches k_VA and k_HA via a ball-type linear drive, which is not represented here in greater detail, to the adjusting lever element 30.

The spring 26C is provided between a stop element 31 and the sliding sleeve 29. The spring 26C ensures that if the actuating unit 10 fails the drive torque will be transmitted to at least one of the two motor vehicle axles 4 or 5, and that the vehicle can be driven to the nearest repair shop without four-wheel drive. In this, the spring forces of the springs 26A to 26C are adjusted to one another such that in the event of a failure of the actuator system 10, the disk stack 19 of the second clutch k_HA will be acted upon with a surface pressure via the sliding sleeve 29 such that the drive torque will be directed via the clutch k_HA to the rear axle 5 of the motor vehicle or the power train 1. In this, the clutch k_VA is opened and no torque is transmitted to the front axle 4.

It obviously lies within the discretion of the technician to adjust the spring forces of the springs 26A, 26B and 26C relative to one another such that the clutches k_VA and k_HA will be activated in the event of a failure of the actuator system 10 in such a way that the transmission output torque from the main transmission 3 will be distributed in a specific ratio, in other words with a certain degree of distribution between the front axle 4 and the rear axle 5, to the two motor vehicle axles 4 and 5.

In reference to FIG. 7, a further embodiment of the actuator system 10 is represented, in which two actuators 12A, 12B are provided for activating the clutch k_VA and k_HA. The actuators 12A and 12B, respectively, actuate the separately constructed ball-type linear drives 33 and 34 to activate the clutches k_VA and k_HA. The activation of the actuators 12A and 12B is coupled with one another such that in each case an activation of the one clutch k_VA or k_HA corresponds to the activation of the other clutch k_HA or k_VA. The activation of the clutches k_VA and k_HA is such that the transmission capacity of the clutch k_VA or the clutch k_HA is varied, while the transmission capacity of the other clutch k_VA or k_HA is constantly held to a value which brings about a synchronous state of this clutch k_HA or k_VA.

The nuts 33A and 34A of the ball-type linear drives 33 and 34 are linearly fixed on the drive shaft 20 and are rotatably connected to the electric motors 12A and 12B, wherein a rotation of the nuts 33A and 34A via ball screws 33B and 34B is transmitted to spindles 33C and 34C of the ball-type linear drives 33 and 34. The spindles 33C and 34C are rotationally fixed on the housing side and are arranged on the drive shaft 20 such that they can move translationally in the axial direction of the drive shaft 20 in order to activate the clutches k_VA and k_HA.

### REFERENCE NUMERALS

1 power train
2 motor
3 main transmission
4 drivable motor vehicle axle, front axle
5 drivable motor vehicle axle, rear axle
6 drive gear
7 drive gear
8 cross distributor gear
9 cross distributor gear
10 actuator system
11 transfer case
12 actuator
12A, B actuator
13 converter apparatus
14 ball-type linear drive
14A ball screw
14B spindle
15 ball-type linear drive
15A ball screw
15B spindle
16 nut
16A, B nut
17 housing-fast component
18 disk stack
18A internal disks
18B external disks
18C internal disk carrier
19 disk stack
19A internal disks
19B external disks
19C external disk carrier
20 drive shaft
22 spindle
23A, B axial needle bearing
24A, B spring device
25 ball-type linear drive
25A ball screw
25B nut
25C spindle
26 spring system
26A, B, C spring
27 component
28 axial needle bearing
29 sliding sleeve valve
30 adjusting lever element
31 stop element
33 ball-type linear drive
33A nut
33B ball screw
33C spindle
34 ball-type linear drive
34A nut
34B ball screw
34C spindle
k_VA first clutch
k_HA second clutch
I_VA longitudinal distributor power train, front axle
I_HA longitudinal distributor power train, rear axle
gvt curve of distributor intensity
gk_VA curve of the transmission capacity of the first clutch
gk_HA curve of the transmission capacity of the second clutch
W(u) lower threshold of the transmission capacity of the clutches
W(o) upper threshold of the transmission capacity of the clutches
VA front axle
HA rear axle

1-13. (canceled)

14. A power train (1) of a motor vehicle having at least two drivable motor vehicle axles (4, 5), the power train (1) having a main transmission (3) arranged between a motor (2) and the two drivable motor vehicle axles (4, 5) for representing various gear ratios, and with a controllable and a regulatable friction-locking clutch (k_VA, k_HA) arranged between the main transmission (3) and each of the motor vehicle axes (4, 5), respectively, whose transmission capacity is adjustable by way of an actuator system (10), and drive torque is distributable between the two drivable motor vehicle axles (4, 5) as a function of set transmission capacities of the controllable and the regulatable friction-locking clutches (k_VA, k_HA).

15. The power train of a motor vehicle 14, wherein the transmission capacity of the controllable and the regulatable friction-locking clutches (k_VA, k_HA) is controlled and regulated by a common actuator (12).

16. The power train according to claim 14, wherein the transmission capacities of the controllable and the regulatable friction-locking clutches (k_VA, k_HA) is controlled and regulated by separate actuators (12A, 12B).

17. The power train according to claim 15, wherein the common actuator (12; 12A, 12B) is an electric motor whose rotational drive motion is converted by a converter apparatus (13) into translational activation for the controllable and the regulatable friction-locking clutches (k_VA, k_HA).

18. The power train according to claim 17, wherein the converter apparatus (13) has two ball-type linear drives (14, 15; 33, 34) which are operatively connected to one another.

19. The power train according to claim 17, wherein ball-type linear drives (14, 15) comprise a common nut (16), which is fixed in place in an axial direction and is rotationally driven by the electric motor (12), and a spindle (14B, 15B), respectively, rotation of the common nut (16) results in corresponding translational movements of the spindle (14B, 15B) such that the transmission capacity of a first of the controllable and the regulatable friction-locking clutches (k_VA or k_HA) varies and the transmission capacity of the second of the controllable and the regulatable friction-locking clutches (k_VA or k_HA) is held at a value that corresponds to a synchronous state for the second of the controllable and the regulatable friction-locking clutches (k_VA or K_HA).

20. The power train according to claim 18, wherein the ball-type linear drives (14, 15) comprise a common spindle (22), which is fixed in place in an axial direction and is non-rotatable, on which two nuts (16A, 16B) are arranged, which can be rotationally driven by the electric motor (12) and which during a rotation, as a function of a thread pitch of the ball-type linear drives (14, 15), execute translational movement corresponding with one another for activation of the controllable and the regulatable friction-locking clutches (k_VA, k_HA) such that the transmission capacity of a first of the controllable and the regulatable friction-locking clutches (k_VA or k_HA) varies and transmission capacity of the second of the controllable and the regulatable friction-locking clutches (k_HA or k_VA) is held at a value which corresponds to a synchronous state for the second of the controllable and the regulatable friction-locking clutches (k_HA or k_VA).

21. The power train according to claim 17, wherein the converter apparatus (13) has only one ball-type linear drive (25), at least one spring system (26) is arranged between the controllable and the regulatable friction-locking clutches (k_VA, k_HA) and the ball-type linear drive (25), by which, during a translational activation motivation of the ball-type linear drive (25), at the same time activations of the controllable and the regulatable friction-locking clutches (k_VA, k_HA) respectively opposite one another can be generated such that the transmission capacity of a first of the controllable and the regulatable friction-locking clutches (k_VA or k_HA) varies and the transmission capacity of the second of the controllable and the regulatable friction-locking clutches (k_HA or k_VA) is held at a value which corresponds to a synchronous state for the second of the controllable and the regulatable friction-locking clutches (k_VA, k_HA).

22. The power train according to claim 14, wherein the actuator system (10) is constructed with one actuator (12A, 12B) and a corresponding ball-type linear drive (33, 34) for each of the controllable and the regulatable friction-locking clutches (k_VA, k_HA), the actuation of the actuators (12A, 12B) is coupled to one another, and in each case an activation of a first of the controllable and the regulatable friction-locking clutches (k_VA) is adapted to activation of a second of the controllable and the regulatable friction-locking clutches (k_HA) such that the transmission capacity of the first clutch (k_VA or k_HA) varies and the transmission capacity of the second clutch (k_HA or k_VA) is held at a value which corresponds to a synchronous state for the second clutch (k_HA or k_VA).

23. A method for controlling and regulating a power train (1) with at least two drivable motor vehicle axles (4, 5), the power train (1) having a main transmission (3) arranged between a motor (2) and the two drivable motor vehicle axles (4,5) for representing various gear ratios, and with a controllable and a regulatable friction-locking clutch (k_VA, k_HA) arranged between the main transmission (3) and each of the two drivable motor vehicle axes (4, 5), respectively, whose transmission capacity is adjustable by an actuator system (10), and drive torque is distributable between the two drivable motor vehicle axles (4, 5) as a function of set transmission capacities of the controllable and the regulatable friction-locking clutches (k_VA, k_HA), the method comprising the steps of:
adjusting transmission capacity of the two clutches (k_VA, k_HA) such that a first clutch (k_VA, k_HA) has a synchronous state; and
varying transmission capacity of a second clutch (k_HA or k_VA) between a lower threshold (W(u)) and an upper threshold (W(o)), which corresponds to a synchronous state for the second clutch (k_VA, k_HA).

24. The method according to claim 23, further comprising the step of, in the presence of the lower threshold (W(u)) of the transmission capacity of the clutches (k_VA, k_HA), transmitting essentially no torque from the first and the second clutches (k_VA, k_HA); and
entirely transmitting at least nearly loss-free a drive torque bearing on one clutch (k_VA, k_HA) in the synchronous state of the first and the second clutches (k_VA, k_HA).

25. The method according to claim 23, further comprising the step of directing essentially no drive torque to one of the two derivable motor vehicle axles (4 or 5) that is connected downstream from this clutch (k_VA or k_HA) in the presence of a transmission capacity of one clutch (k_VA or k_HA) that corresponds to the lower threshold (W(u)); and
essentially entirely directing the drive torque of the motor to the other of the two derivable motor vehicle axles (5 or 4) that is connected downstream from a synchronous clutch (k_VA or k_HA).

26. The method according to claim 23, further comprising the step of varying a degree of distribution of the drive torque between the two motor vehicle axles (4, 5) as a function of the transmission capacity of the clutch (k_VA, k_HA) whose transmission capacity is being altered.
